(19) United States
(12) Patent Application Publication
(10) Pub. No.: US 2001/0050822 A1
(43) Pub. Date: Dec. 13, 2001

(54) Fender mirror mount

(76) Inventor: Edward J. Phillips, Kansas City, MO (US)

Correspondence Address: CHASE & YAKIMO, L.C., 4400 COLLEGE BOULEVARD, SUITE 130, OVERLAND PARK, KS, 66211

(21) Appl. No.: 09/879,721

(22) Filed: Jun. 12, 2001

Related U.S. Application Data
(60) Provisional application No. 60/211,160, filed on Jun. 13, 2000.

(51) Int. Cl. G02B 7/182

(52) U.S. Cl. 359/871; 359/843

(57) ABSTRACT

An improved fender mirror mount for use with plastic fenders provides a durable mount for all vehicle operations, reduces normal stresses at the mounting points, reduces vibrations to the mirror, is simple to install, and reduces the maintenance cost of vehicles with plastic fenders. The mirror mount assembly transfers forces acting upon the free end of the mirror guide bar into planar forces at the mounting points acting in the planes of the fender. The assembly comprises an upright guide bar mounted at its lower portion to the fender, a mirror movably mounted to the upper portion of the guide bar, a front brace that secures the guide bar to the top of the fender, and a side brace that secures the guide bar to the rearward sidewall of the fender. Connections between the guide bar, the braces and the fender are made using rubber collars and grommets to isolate the assembly from fender vibrations.

### BACKGROUND OF THE INVENTION

This invention relates a mirror assembly for vehicles and, more particularly, to an improved fender mirror mount for use with plastic fenders.

A number of mounting assemblies for fender-mounted mirrors for vehicles, including postal vehicles or the like, are known. Problems have arisen with these conventional fender-mounted mirrors with the introduction and increasing use of plastic fenders. Plastic fenders are thin and provide little support for a fender-mounted mirror. A mounting arm bolted to the fender at one end and having a mirror attached to the free end acts as a moment arm about the mounting bolts putting stress on the fender at the mounting point normal to the fender surface. Over time, the fender may fail at the mounting point due to normal vibrations from the engine or road as the vehicle is driven, or from stresses from the wind. Additionally, these mirror assemblies may be torn from the fender by minor collisions with obstructions such as tree limbs or bushes, or by vandals.

### SUMMARY OF THE INVENTION

It is therefore the primary object of the present invention to provide a mirror mount assembly for use with vehicles having plastic fenders.

A further object of the present invention is to provide a device, as aforesaid, which reduces normal stresses at the mounting points.

Another important object of the present invention is to provide a device, as aforesaid, which has a durable mount for all vehicle operations.

Still another object of the present invention is to provide a mirror assembly, as aforesaid, which reduces vibrations to the mirror.

A still further important object of the present invention is to provide a mirror assembly, as aforesaid, which is simple to install.

Yet another object of the present invention, as aforesaid, is to provide a mirror assembly which reduces the maintenance cost of vehicles with plastic fenders.

These and other objects of the invention are achieved by a fender-mounted mirror assembly that transfers forces acting upon the free end of the mirror assembly into planar forces at the mounting points acting in the planes of the fender. In this way forces are transmitted in a direction of the greatest strength of the fender which is planar, and minimized in the direction which is of the least strength of the fender which is normal to the fender.

Other objects and advantages of this invention will become apparent from the following description taken in connection with the accompanying drawings, wherein is set forth by way of illustration and example, an embodiment of this invention.

### BRIEF DESCRIPTION OF THE DRAWINGS

FIG. 1 is a perspective view of a fender-mounted mirror assembly mounted to a plastic fender;

FIG. 2 is a side view of the fender-mounted mirror assembly;

FIG. 3 is a side diagrammatic view showing force vectors;

FIG. 4 is a front diagrammatic view showing force vectors; and

FIG. 5 is a side view of a fender-mounted mirror assembly showing an alternative side brace.

### DESCRIPTION OF THE PREFERRED EMBODIMENT

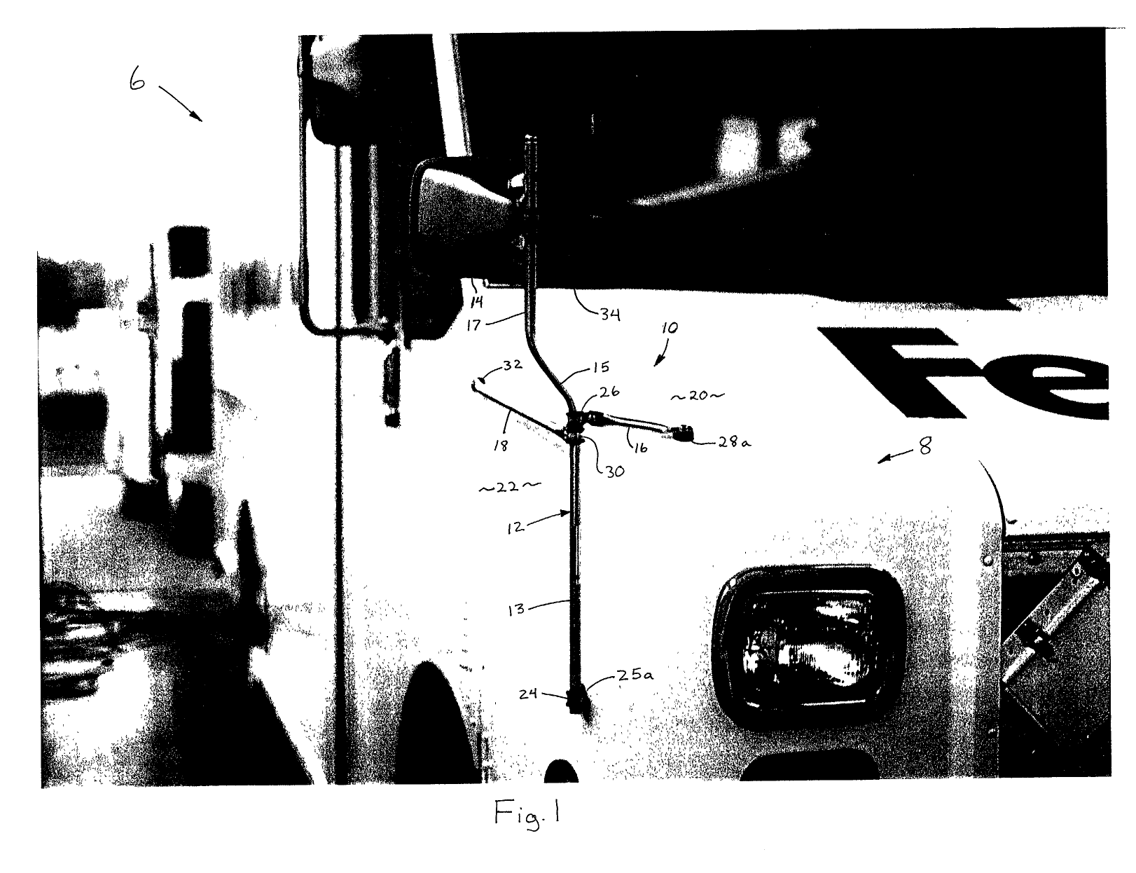

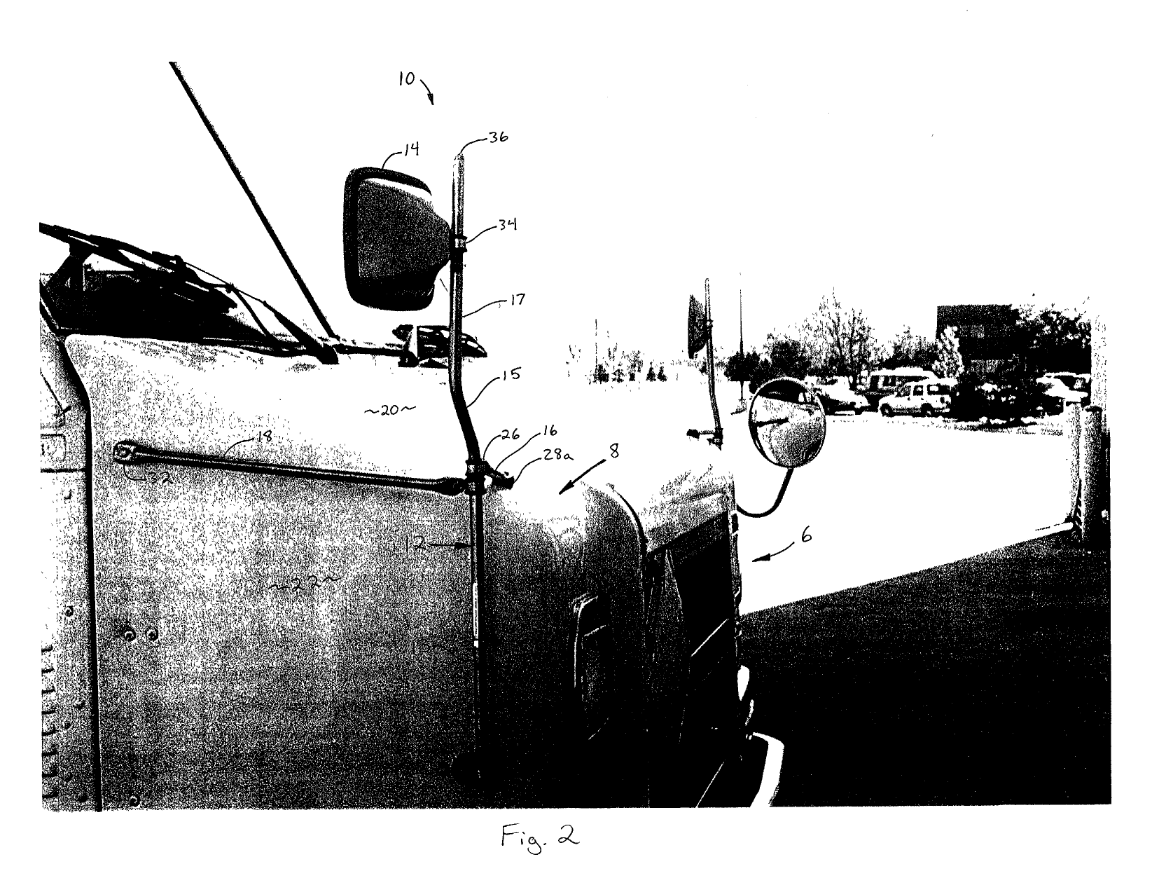

Turning more particularly to the drawings, FIGS. 1 and 2 illustrate a fender-mounted mirror assembly 10 mounted on a plastic fender 8 of delivery vehicle 6. Mirror mount 10 is comprised of a generally upright guide bar 12, a mirror 14, a front brace 16, and a side brace 18.

Guide bar 12 is generally upright with a lower portion 13, an intermediate portion 15, and an upper portion 17. Intermediate portion 15 extends upwardly from lower portion 13 and outwardly from fender 8 to provide the driver of vehicle 6 with a better view in mirror 14 down the side of the vehicle 6. Mirror 14 is mounted to upper portion 17 extending upwardly from intermediate portion 15.

Guide bar 12 is attached to a sidewall 22 of fender 8 by a steel clip with a rubber collar 24 which is secured to fender 8. A pair of rubber grommets 25a and 25b (FIG. 4) isolate guide bar 12 from fender sidewall 22 to reduce vibrations that can distort images reflected in mirror 14, and weaken sidewall 22 at the mounting point. A running light or turn signal light 36 may be mounted to the free end of guide bar 12.

Guide bar 12 is stabilized by front brace 16 and side brace 18. As shown in FIG. 4, front brace 16 is secured to the generally horizontal top wall 20 of fender 8. A pair of rubber grommets 28a and 28b isolate front brace 16 from fender top wall 20 to reduce vibrations and to distribute the mounting stresses about the mounting hole. Front brace 16 is attached to guide bar 12 at the upper end of lower member 13 using a steel clip with a rubber collar 26. Side brace 18 is secured to fender sidewall 22. A pair of rubber grommets 32 (inside grommet not shown) are used to reduce vibrations from vehicle 6 in side brace 18. Side brace 18 is attached to guide bar 12 at the upper end of lower member 13 by a steel clip with a rubber collar 30.

Guide bar 12, front brace 16 and side brace 18 are arranged in a generally perpendicular relationship. The relationship between the members of fender mirror mount 10 may be described with reference to the X-Y-Z Cartesian coordinate system. Guide bar 12 is generally vertical and falls along the Y-axis. Front brace 16 is generally horizontal and falls along the X-axis. Side brace 18 is generally horizontal and falls along the Z-axis. Mounting clips 26 and 30 are generally at the origin or intersection of the X, Y, and Z-axes. Guide bar 12 and front bracket 16 fall generally into the X-Y plane. Guide bar 12 and side brace 18 fall generally in the Y-Z plane which is generally the plane of sidewall 22. Front brace 16 and side brace 18 generally fall in the X-Z plane which is generally the plane of top wall 20. It should be understood that the angle between side brace 18 and guide bar 12 and front brace 16 and guide bar 12 may vary depending on the contour of fender 8 and need not be 90° nor must pairs of braces be co-planar.

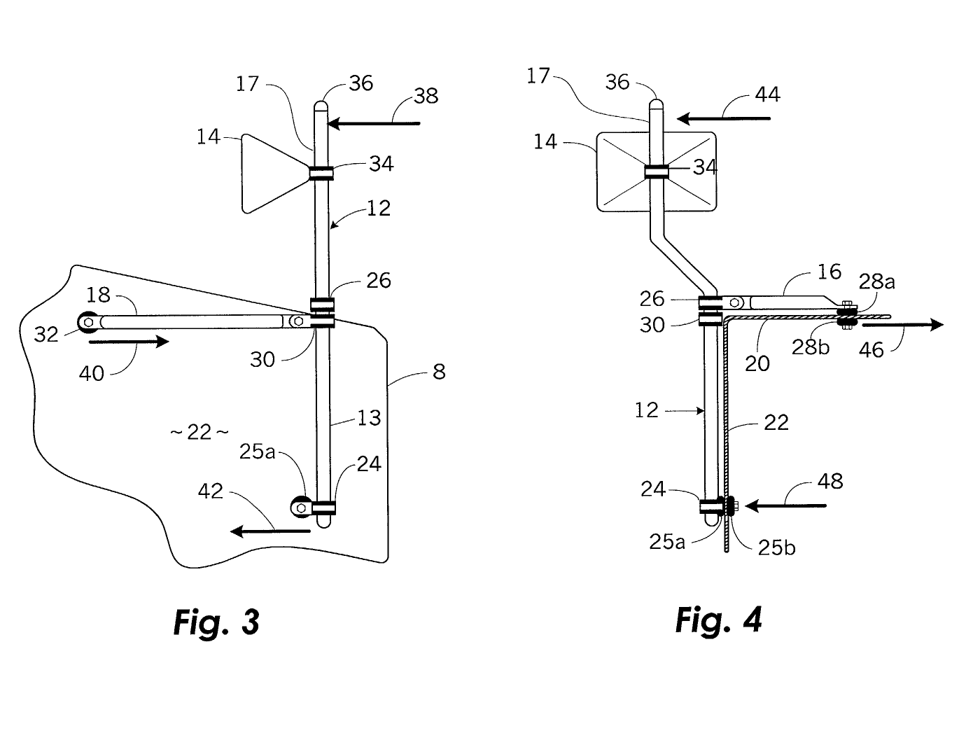

As shown in FIG. 3, a force vector 38 acting in the Z direction upon the free end 17 of guide bar 12 induces Y-Z planar reaction forces 40 and 42. Force vector 38 may be caused by the wind as vehicle 6 is driven, or if guide bar 12 strikes an object such as a tree limb. The reactive forces 40 and 42 induced in sidewall 22 are planar forces in the direction of greatest strength of sidewall 22.

Referring to FIG. 4, force vector 44 acting on the upper member 17 of guide bar 12 induces reactive forces 46 and 48 in fender top wall 20 and fender sidewall 22, respectively. Reactive force 46 is generally in the X-Z plane of the upper wall 20. Force 44 also induces the reactive force 48 which prevents the end of guide bar 12 from being pushed through fender sidewall 22. The reactive forces 46 and 48 are in directions of inherent strength of the plastic fender 8.

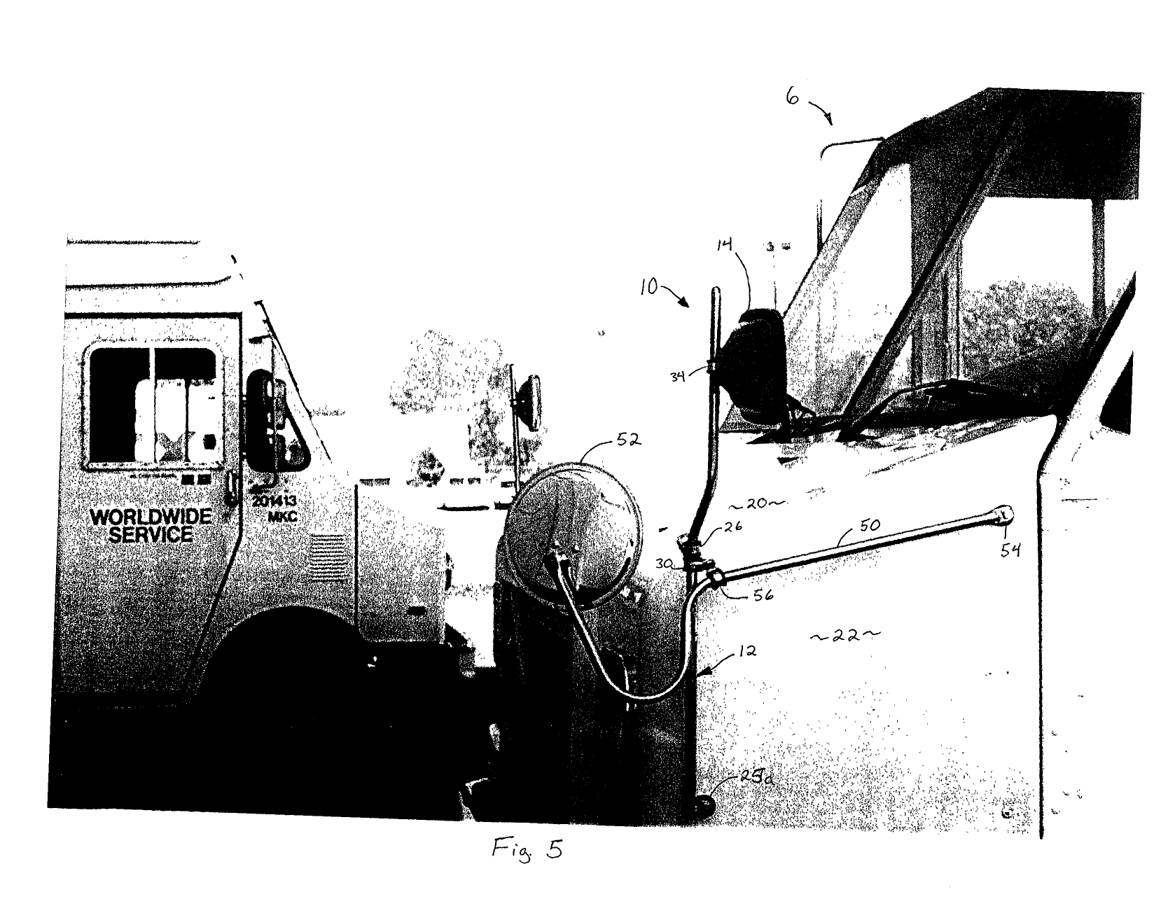

Referring to FIG. 5, fender mirror mount 10 is shown with an alternate embodiment of side brace 50. Side brace 50 is generally J-shaped with a mirror 52 attached to free end 53 for viewing objects in front of vehicle 6. Side brace 50 is secured to fender sidewall 22 through a pair of rubber grommets 54 (inside grommet not shown) to isolate vibrations from the vehicle 6 and from the mirror mounting assembly 10. Side brace 50 is secured to guide bar 12 by coupling steel clip and rubber collar 56 to clip 30.

It is to be understood that while certain forms of this invention have been illustrated and described, it is not limited thereto, except in so far as such limitations are included in the following claims and equivalents thereof.

Having thus described the invention, what is claimed as new and desired to be secured by Letters Patent is as follows:

1. In combination with a vehicle fender having a sidewall and a top wall, a mirror mount assembly comprising:
a guide bar having a lower end, an intermediate portion, and an upper end, said lower end being fixed to said sidewall of said fender, said intermediate portion extending upwardly from said lower end, said upper end extending upwardly from said intermediate portion;
a front brace having a first end secured to said top wall of said fender, and a second end extending laterally and outwardly from said fender and secured to said intermediate portion of said guide bar; and
a side brace having a first end secured to said sidewall of said fender, and a second end extending forwardly and secured to said intermediate portion of said guide bar.

2. In combination with a vehicle having first and second front fenders, each having an upwardly extending sidewall and a generally horizontal top wall, a mirror mount assembly comprising:
a guide bar having a lower upright portion, an intermediate portion, and an upper portion, said lower upright portion having a lower end mounted to said sidewall of said first fender and extending upwardly to said intermediate portion, said intermediate portion extending upwardly and outwardly from said lower upright portion and said first front fender, said upper portion extending upwardly from said intermediate portion;
a mirror mounted on said upper portion of said guide bar;
a front brace having a first end secured to said top wall of said first front fender, and a second end extending laterally and outwardly from said first front fender and secured to said intermediate portion of said guide bar; and
a side brace having a first end secured to said sidewall of said first fender, and a second end extending forwardly and secured to said intermediate portion of said guide bar, whereby forces applied to said guide bar are transmitted to said front and side braces and then to a surface of said first fender in a direction in a plane of said surface.

3. In combination with a vehicle having first and second front plastic fenders, each having an upwardly extending sidewall and a generally horizontal top wall, a mirror mount assembly comprising:
a guide bar having a lower upright portion, an intermediate portion, and an upper portion, said lower upright portion having a lower end and rubber collar means securing said lower end to said sidewall of said first fender, said intermediate portion extending upwardly and outwardly from said lower upright portion and said first front fender, said upper portion extending upwardly from said intermediate portion;
a mirror mounted on said upper portion of said guide bar;
a front brace having a first end and rubber grommet means securing said first end to said top wall of said first front fender, and a second end extending laterally and outwardly from said first front fender and having rubber collar means securing said second end to said intermediate portion of said guide bar;
a side brace having a first end and rubber grommet means securing said first end of the side brace to said sidewall of said first fender, and a second end extending forwardly and having rubber collar means securing said second end of the side brace to said intermediate portion of said guide bar;
whereby said mirror mount assembly is isolated from said fenders to reduce vibrations transmitted from vehicle fenders to the guide bar, and forces applied to said guide bar are transmitted to said front and side braces and then to a surface of said first fender in a direction in a plane of said surface.

4. The mirror mount assembly of claim 3 wherein each of said rubber collar means comprises:
a clip with a rubber collar which encircles and engages the associated bar or brace.

5. The mirror mount assembly of claim 3 wherein each of said rubber grommet means includes a pair of spaced rubber grommets engaging opposed faces of the associated fender wall.

6. The mirror mount assembly of claim 3 wherein said side brace is generally J-shaped and includes a mounting structure for a mirror at a terminus of said second end thereof.
